(19) United States
(12) Patent Application Publication
(10) Pub. No.: US 2024/0273659 A1
(43) Pub. Date: Aug. 15, 2024

(54) BUSINESS ACTIVITY SIZE ESTIMATION DEVICE AND COMPUTER-READABLE STORAGE MEDIUM STORING BUSINESS ACTIVITY SIZE ESTIMATION PROGRAM

(71) Applicant: Hiroaki ANDO, Tokyo (JP)

(72) Inventor: Hiroaki ANDO, Tokyo (JP)

(21) Appl. No.: 18/438,656

(22) Filed: Feb. 12, 2024

(30) Foreign Application Priority Data
Feb. 13, 2023 (JP) 2023-020223

(51) Int. Cl. G06Q 50/18

(52) U.S. Cl. CPC G06Q 50/184

(57) ABSTRACT

A business activity size estimation device acquires patent publications having an estimation-subject company as applicant and/or patent publications appended with a higher level patent classification corresponding to an estimation-subject business activity, counts appended genera of a lower level patent classification appended to the acquired patent publications, and uses a correlation of the counted appended genera of the lower level patent classification correlated with a business activity size of the estimation-subject company and/or a size of the estimation-subject business activity to estimate the business activity size of the estimation-subject company and/or the size of the estimation-subject business activity.

### BACKGROUND

### Technical Field

The present exemplary embodiments relate to a business activity size estimation device and to a program for business activity size estimation.

### Related Art

Patent Document 1 (Japanese Patent Application Laid-Open (JP-A) No. 2019-32614) describes an embodiment that, by performing machine learning on a model, uses documentation information of a patent publication to estimate a business activity stage of a business activity performed by the applicant thereof

Non-Patent Document 1 (“Empirical Analysis Regarding the Effect of Patents on Company Performance” by Hiromitsu NAKAGAWA in Annals of Japan Association of Evolutionary Economics, 2004, Volume 8, pp 187 to 196) describes a detailed analysis of the correlation between the number of patents and the revenue of respective companies in the Japanese electric machinery industry. There is also reference to analysing for a relationship between the number of patents and profit in the pharmaceutical sector.

### SUMMARY

When a company is setting a business activity strategy, there is a desire to be able to estimate a capability comparator between the company and a competing company, to estimate revenue in a business activity of the company and a competing company, to estimate business activity budget allocation of the company and a competing company, to estimate a trend in business activity of the company and a competing company, and the like.

The technology described in Patent Document 1 must execute processing to perform machine learning on a model using document information of patent publications, readily leading to complicated processing, and is unable to build a system.

Moreover, although a relationship between a number of patents and revenue may sometimes be established when looking at particular company association for companies originating in the same country and having similar circumstances, such a relationship is unable to be generalized across, for example, companies having different countries of origin. Thus the technology described in Non-Patent Document 1 has a low estimation accuracy of revenue when generalized, and lacks reliability.

The present exemplary embodiments address estimation of a size of business activity that, compared to technology hitherto, is able to be performed with simpler processing while also achieving higher accuracy.

A first aspect is a business activity size estimation device including an acquisition section, a count section, and an estimation section. The acquisition section acquires patent publications having an estimation-subject company as applicant (used with a meaning including a body that has received a right to be granted a patent, and a patent rights holder) and/or patent publications appended with a higher level patent classification corresponding to an estimation-subject business activity. The count section counts appended genera of a lower level patent classification appended to the patent publications acquired by the acquisition section. The estimation section uses a correlation of appended genera of the lower level patent classification as counted by the count section correlated with a business activity size of the estimation-subject company and/or a size of the estimation-subject business activity to estimate the business activity size of the estimation-subject company and/or the size of the estimation-subject business activity.

A second aspect is the business activity size estimation device of the first aspect, wherein the count section removes duplication from and counts the appended genera of the lower level patent classification appended to the patent publications acquired by the acquisition section.

A third aspect is the business activity size estimation device of the first aspect, wherein the lower level patent classification is an International Patent Classification subgroup, or main-group, or subclass.

A fourth aspect is the business activity size estimation device of the first aspect, wherein the estimation section estimates at least one out of capability, business activity revenue, or business activity budget allocation.

A fifth aspect is the business activity size estimation device of the first aspect, wherein the estimation section estimates at least one out of a change in capability, a change in business activity revenue, a change in business activity budget allocation, or a business activity trend by computing a timewise change rate of appended genera of the lower level patent classification and by estimating a change of business activity size of the estimation-subject company and/or a change of size of the estimation-subject business activity according to the computed timewise change rate of appended genera of the lower level patent classification.

A sixth aspect is the business activity size estimation device of the first aspect, wherein the estimation section estimates at least one out of a change in capability, a change in business activity revenue, a change in business activity budget allocation, or a business activity trend by computing appended genera of the lower level patent classification for each category of the higher level patent classification and by estimating a change of business activity size for each category of the higher level patent classification according to a timewise change rate of the computed appended genera of the lower level patent classification.

A seventh aspect is a business activity size estimation device including a first acquisition section, a second acquisition section, a first count section, a second count section, a computation section, and an estimation section. The first acquisition section acquires patent publications appended with a higher level patent classification corresponding to an estimation-subject business activity. The second acquisition section acquires patent publications having an estimation-subject company as applicant from out of the patent publications acquired by the first acquisition section. The first count section counts first appended genera of a lower level patent classification appended to the patent publications acquired by the first acquisition section. The second count section counts second appended genera of a lower level patent classification appended to the patent publications acquired by the second acquisition section. The computation section computes an appended genera share of the second appended genera of the lower level patent classification divided by the first appended genera of the lower level patent classification. The estimation section uses the appended genera share as computed by the computation section to estimate a business activity size share made up by the business activity size of the estimation-subject company in a size of the estimation-subject business activity.

An eighth aspect is a business activity size estimation device including an acquisition section, a result value acquisition section, a count section, and a prediction model generation section. The acquisition section acquires patent publications having an estimation-subject company as applicant. The result value acquisition section acquires a business activity size result value indicating a result value of a size of business activity corresponding to a higher level patent classification appended to the patent publications acquired by the acquisition section. The count section counts appended genera of a lower level patent classification in each category of the higher level patent classification appended to the patent publications acquired by the acquisition section. The prediction model generation section generates a business activity size prediction model that is a prediction model to predict appended genera of the lower level patent classification and/or a size of business activity based on an appended genera count value as counted by the count section for the lower level patent classification in each category of the higher level patent classification and based on the business activity size result value as acquired by the result value acquisition section, and that is a prediction model taking the appended genera of the lower level patent classification as an explanatory variable and the business activity size as an objective variable.

A ninth aspect is the business activity size estimation device of the eighth aspect, wherein the business activity size prediction model is a model taking appended genera of lower level patent classification for each of plural categories of higher level patent classification as plural explanatory variables, and taking a business activity size corresponding to the plural categories of the higher level patent classification as the objective variable.

A tenth aspect is a program to cause business activity size estimation to be executed by a computer and including acquisition processing to acquire patent publications having an estimation-subject company as applicant and/or patent publications appended with a higher level patent classification corresponding to an estimation-subject business activity.

The business activity size estimation also includes count processing to count appended genera of a lower level patent classification appended to the patent publications acquired by the acquisition processing, and estimation processing that uses a correlation of the appended genera of the lower level patent classification as counted by the count processing correlated with a business activity size of the estimation-subject company and/or a size of the estimation-subject business activity to estimate the business activity size of the estimation-subject company and/or the size of the estimation-subject business activity.

An eleventh aspect is a program that causes business activity size estimation to be executed by a computer and includes first acquisition processing, second acquisition processing, first count processing, second count processing, computation processing, and estimation processing. The first acquisition processing acquires patent publications appended with a higher level patent classification corresponding to an estimation-subject business activity. The second acquisition processing acquires patent publications having an estimation-subject company as applicant from out of the patent publications acquired by the first acquisition processing. The first count processing counts first appended genera of a lower level patent classification appended to the patent publications acquired by the first acquisition processing. The second count processing counts second appended genera of a lower level patent classification appended to the patent publications acquired by the second acquisition processing. The computation processing computes an appended genera share of the second appended genera of the lower level patent classification divided by the first appended genera of the lower level patent classification. The estimation processing uses the appended genera share as computed by the computation processing to estimate a business activity size share made up by the business activity size of the estimation-subject company in a size of the estimation-subject business activity.

A twelfth aspect is a program that causes business activity size estimation to be executed by a computer and includes acquisition processing, result value acquisition processing, count processing, and prediction model generation processing. The acquisition processing acquires patent publications having an estimation-subject company as applicant. The result value acquisition processing acquires a business activity size result value indicating a result value of a size of business activity corresponding to a higher level patent classification appended to the patent publications acquired by the acquisition processing. The count processing counts appended genera of a lower level patent classification in each category of the higher level patent classification appended to the patent publications acquired by the acquisition processing. The prediction model generation processing generates a business activity size prediction model that is a prediction model to predict appended genera of the lower level patent classification and/or a size of business activity based on an appended genera count value as counted by the count processing for the lower level patent classification in each category of the higher level patent classification and based on the business activity size result value as acquired by the result value acquisition processing, and that is a prediction model taking the appended genera of the lower level patent classification as an explanatory variable and the business activity size as an objective variable.

The first aspect to the twelfth aspect are according able to perform estimation of a size of business activity that, compared to technology hitherto, is able to be performed with simpler processing while also achieving higher accuracy.

### BRIEF DESCRIPTION OF THE DRAWINGS

FIG. 1 is a block diagram illustrating a functional configuration of a business activity size estimation device of a first exemplary embodiment.

FIG. 2 is a block diagram illustrating a functional configuration of a business activity size estimation device of a second exemplary embodiment.

FIG. 3 is a block diagram illustrating a functional configuration of a business activity size estimation device of a third exemplary embodiment.

FIG. 4 is a configuration diagram of an exemplary embodiment including a single or plural personal computer terminals, a server, and a network connecting each of the personal computer terminals and the server together so as to enable inter-communication therebetween.

FIG. 5 is a configuration diagram of hardware to implement a functional configuration of an exemplary embodiment.

FIG. 6A is a flowchart of a processing sequence of a program for business activity size estimation to implement functions of a business activity size estimation device.

FIG. 6B is a flowchart of a processing sequence of a program for business activity size estimation to implement functions of a business activity size estimation device.

FIG. 6C is a flowchart of a processing sequence of a program for business activity size estimation to implement functions of a business activity size estimation device.

FIG. 7A is a diagram to explain acquisition processing performed by an acquisition section of a first exemplary embodiment.

FIG. 7B is a diagram to explain acquisition processing performed by an acquisition section of a first exemplary embodiment.

FIG. 8 is a diagram to explain appended genera N, and is a diagram corresponding to an acquisition publication information display field illustrated in FIG. 7B.

FIG. 9A is a diagram illustrating an example of appended genera of a higher level patent classification and a lower level patent classification.

FIG. 9B is a diagram illustrating an example of a correlation pre-stored in a database of a server.

FIG. 10A is a diagram illustrating an example of an estimation screen of a user-side terminal display device.

FIG. 10B is a diagram illustrating an example of an estimation screen of a user-side terminal display device.

FIG. 10C is a diagram illustrating an example of an estimation screen of a user-side terminal display device.

FIG. 10D is a diagram illustrating an example of an estimation screen of a user-side terminal display device.

FIG. 11A is a diagram illustrating an example of an estimation screen of a user-side terminal display device.

FIG. 11B is a diagram illustrating an example of an estimation screen of a user-side terminal display device.

FIG. 12A is a diagram illustrating an example of an estimation screen of a user-side terminal display device.

FIG. 12B is a diagram illustrating an example of an estimation screen of a user-side terminal display device.

FIG. 13A is a diagram illustrating an example of an estimation screen of a user-side terminal display device.

FIG. 13B is a diagram illustrating an example of an estimation screen of a user-side terminal display device.

FIG. 14A is a diagram illustrating an example of regression coefficients.

FIG. 14B is a diagram illustrating a regression curve corresponding to a business activity size prediction model.

FIG. 15A is a diagram illustrating an example of an estimation screen of a user-side terminal display device.

FIG. 15B is a diagram illustrating an example of an estimation result display screen of a user-side terminal display device.

FIG. 15C is a diagram illustrating an example of an estimation result display screen of a user-side terminal display device.

### DETAILED DESCRIPTION

Explanation follows regarding exemplary embodiments, with reference to the drawings.

Functional Configuration of Business Activity size Estimation Device

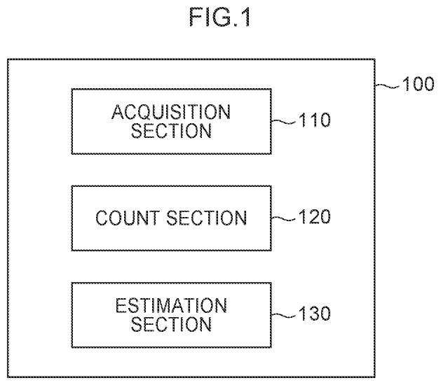

FIG. 1 is a block diagram illustrating a functional configuration of a business activity size estimation device 100 of a first exemplary embodiment.

The business activity size estimation device 100 of the first exemplary embodiment is configured including an acquisition section 110, a count section 120, and an estimation section 130.

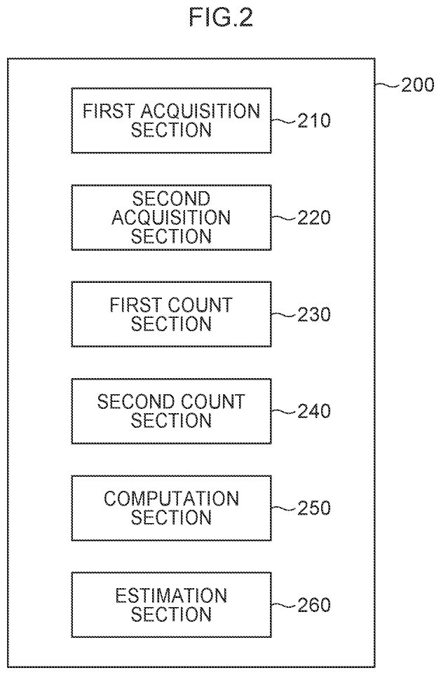

FIG. 2 is a block diagram illustrating a functional configuration of a business activity size estimation device 200 of a second exemplary embodiment.

The business activity size estimation device 200 of the second exemplary embodiment is configured including a first acquisition section 210, a second acquisition section 220, a first count section 230, a second count section 240, a computation section 250, and an estimation section 260.

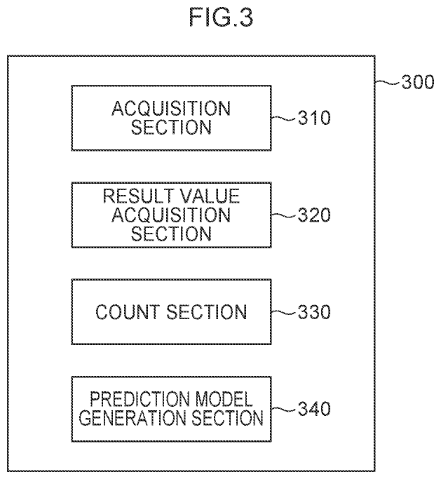

FIG. 3 is a block diagram illustrating a functional configuration of a business activity size estimation device 300 of a third exemplary embodiment.

Then business activity size estimation device 300 of the third exemplary embodiment is configured including an acquisition section 310, a result value acquisition section 320, a count section 330, and a prediction model generation section 340.

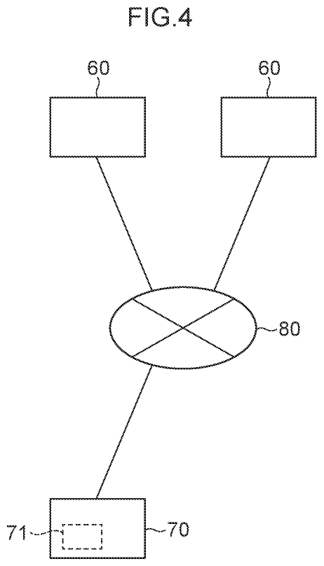

The functions in FIG. 1, FIG. 2, and FIG. 3 can be implemented by a combination, as illustrated in FIG. 4, of a single or plural personal computer terminal 60, a server 70, and a network 80 connecting each of the personal computer terminals 60 and the server 70 together so as to enable inter-communication therebetween. Implementation may also be by a standalone personal computer terminal 60.

### Hardware Configuration

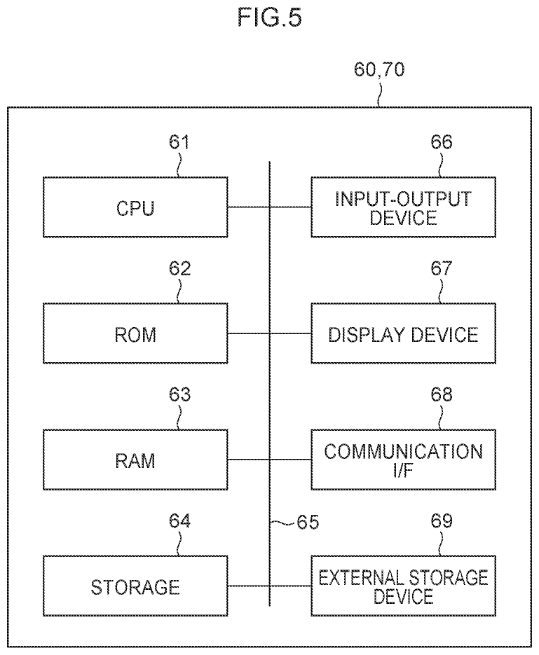

FIG. 5 is a diagram of a hardware configuration for implementing the functional configurations of the first exemplary embodiment, the second exemplary embodiment, and the third exemplary embodiment illustrated in FIG. 1, FIG. 2, and FIG. 3. FIG. 5 illustrates an example of a hardware configuration of the personal computer terminal 60 or the server 70.

As illustrated in FIG. 5, the personal computer terminal 60 or the server 70 includes a central processing unit (CPU) 61, read only memory (ROM) 62, random access memory (RAM) 63, storage 64, an input-output device 66, a display device 67, a communication I/F 68, and an external storage device 69, with these being connected together through a system bus 65 so as to enable inter-communication therebetween.

The CPU 61 is a central processing unit that executes various programs and controls each device connected to the system bus 65. Namely, the CPU 61 reads a program from the ROM 62 or the storage 64, and executes the program using the RAM 63 as workspace. The CPU 61 controls each device connected to the system bus 65 and performs various computational processing according to the program recorded on the ROM 62 or the storage 64. A basic input/output system (BIOS) and an operating system (OS), which are control programs for execution by the CPU 61, and various computer readable executable programs and various required data to implement the present exemplary embodiments, are held in the ROM 62 or the storage 64.

The ROM 62 stores various control programs and various data. The RAM 63 serves as an operation region functioning as main memory, a work area, and the like of the CPU 61 and temporarily stores programs and data. The storage 64 is configured by a hard disk drive (HDD) or a solid state drive (SSD), and is stored with various programs including the BIOS and OS, and with various data.

The input-output device 66 includes a pointing device such as a mouse, a keyboard, and a reading device such as scanner, or the like, and is employed for performing various inputs.

The display device 67 is, for example, a liquid crystal display, and displays various information. The display device 67 may employ a touch panel and also function as the input-output device 66.

The communication interface 68 is an interface for communicating with other machines such as a server 70, a terminal 60, or the like and employs a standard such as, for example, Ethernet (registered trademark), FDDI, or Wi-Fi (registered trademark). The communication interface 68 is connected to the network 80 and controls the exchange of data.

The external storage device 69 is configured by a demountably-connected external storage medium, such as various memory cards like USB memory, an HDD, an SSD, or the like.

### Business Activity Size Estimation Program

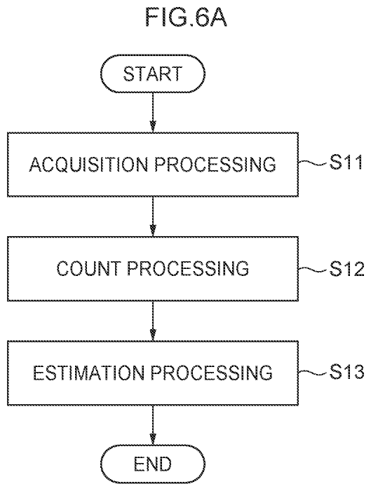

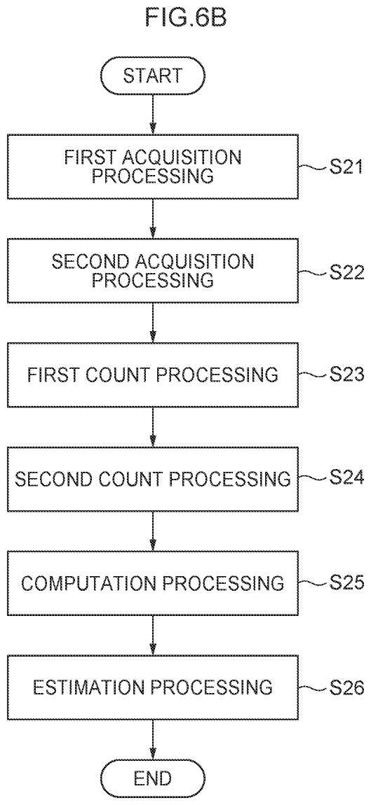

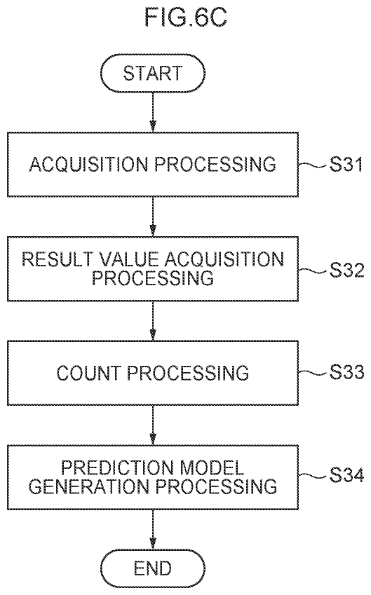

FIG. 6A is a flowchart illustrating a processing sequence of a business activity size estimation program PB1A for causing the functions of the business activity size estimation device 100 to be implemented. The business activity size estimation program PB1A executes acquisition processing S11, count processing S12, and estimation processing S13 on a computer. The acquisition processing S11 corresponds to processing performed in the acquisition section 110. The count processing S12 corresponds to processing performed in the count section 120. The estimation processing S13 corresponds to processing performed in the estimation section 130.

FIG. 6B illustrates a flowchart of a sequence of processing of a business activity size estimation program PB1B for causing the functions of the business activity size estimation device 200 to be implemented. The business activity size estimation program PB1B executes first acquisition processing S21, second acquisition processing S22, first count processing S23, second count processing S24, computation processing S25, and estimation processing S26 on a computer. The first acquisition processing S21 corresponds to processing performed in the first acquisition section 210. The second acquisition processing S22 corresponds to processing performed in the second acquisition section 220. The first count processing S23 corresponds to processing performed in the first count section 230. The second count processing S24 corresponds to processing performed in the second count section 240. The computation processing S25 corresponds to processing performed in the computation section 250. The estimation processing S26 corresponds to processing performed in the estimation section 260.

FIG. 6C illustrates a flowchart of a sequence of processing of a business activity size estimation program PB1C for causing the functions of the business activity size estimation device 300 to be implemented. The business activity size estimation program PB1C executes acquisition processing S31, result value acquisition processing S32, count processing S33, and prediction model generation processing S34 on a computer. The acquisition processing S31 corresponds to processing performed in the acquisition section 310. The result value acquisition processing S32 corresponds to processing performed in the result value acquisition section 320. The count processing S33 corresponds to processing performed in the count section 330. The prediction model generation processing S34 corresponds to processing performed in the prediction model generation section 340.

The programs PB1A, PB1B, PB1C are stored on the ROM 62, or the storage 64, or the external storage device 69. The personal computer terminal 60 or the server 70 reads the programs PB1A, PB1B, PB1C from the ROM 62, or the storage 64, or the external storage device 69, and executes each of the processing thereof. A database 71 configured by the ROM 62, or the storage 64, or the external storage device 69 is provided on the server 70.

Note that whether to perform each of the above processing S11 to S34 on which out of the personal computer terminal 60 or the server 70 may be freely determined according to system configuration. For example, the programs PB1A, PB1B, PBC may be installed on the personal computer terminal 60, and the programs PB1A, PB1B, PBC may be executed on a standalone personal computer terminal 60. Moreover, for example, the processing of the programs PB1A, PB1B, PBC may be executed by both the personal computer terminal 60 and the server 70 by access to the server 70 from the personal computer terminal 60 over the network 80.

Explanation follows regarding each exemplary embodiment.
In the embodiment, several examples will be described that are applied to electrical equipment and semiconductor companies and use the IPC 8th edition. Here, electrical machinery/semiconductor companies are, specifically, a group of companies whose largest appended genera among the appended genera of the IPC subgroups are classified into Section G or Section H during the unit period.

### Computer-readable Storage Medium Storing Business Activity Size Estimation Program

When part or all of the functions of this embodiment are realized by software, the software (computer program) can be provided in a form stored in a computer-readable storage medium. “Computer-readable storage medium ” is not limited to portable recording media such as flexible disks and CD-ROMs, but also various internal storage devices in computers such as RAM and ROM, and fixed devices such as hard disks. It also includes external storage devices. In other words, the term “computer-readable storage medium ” has a broad meaning including any recording medium on which data can be fixed rather than temporarily.

### First Exemplary Embodiment

The business activity size estimation device 100 of the first exemplary embodiment includes the acquisition section 110, the count section 120, and the estimation section 130, and executes the program PB1A having the processing sequence illustrated in FIG. 6A. Acquisition Processing S11 by Acquisition Section 110.

The acquisition section 110 acquires patent publications having the estimation-subject company as applicant and/or patent publications appended with a higher level patent classification corresponding to an estimation-subject business activity (S11).

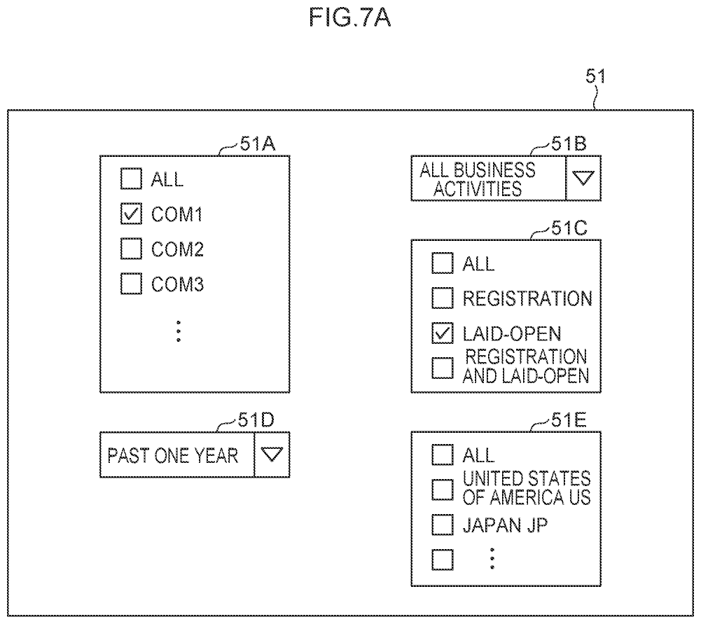

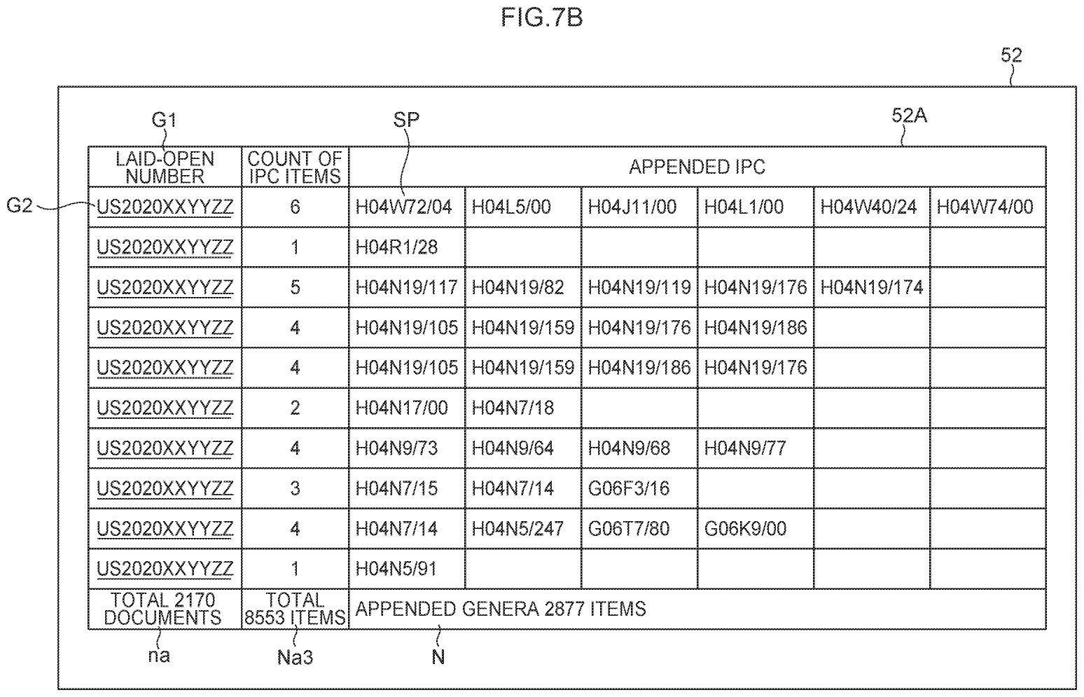

Explanation follows regarding this acquisition processing, with reference to FIG. 7A and FIG. 7B.

FIG. 7A and FIG. 7B are diagrams to explain the acquisition processing performed by the acquisition section 110 of the first exemplary embodiment.

A selection screen 51 is displayed on a screen of the display device 67 of a personal computer terminal 60 provided at the user side (hereafter referred to as user-side terminal) by the user-side terminal 60 accessing the server 70. The selection screen 51 is configured as an interface screen including the functions of the acquisition section 110.

A user is able to perform operations on the selection screen 51 to select the estimation-subject company and/or the estimation-subject business activity.

The selection screen 51 is provided with a company selection field 51A, a business activity selection field 51B, a publication type selection field 51C, an issue period selection field 51D, and an issuing state selection field 51E.

The company selection field 51A may be configured by a pulldown menu, a checkbox, an input text box, or the like for selecting companies. For example, one or plural companies may be selected from out of company names COM1, COM2, COM3, . . .

The business activity selection field 51B may be configured by a pulldown menu, a checkbox, an input text box, or the like for selecting a business activity. For example, one or plural business activities (including all business activities) may be selected as the business activity from out of image communication, semiconductor fabrication, X-ray diagnostic devices, . . . The business activity selectable may be the business activity in the technical field corresponding to a subclass or a main-group or the like of the International Patent Classification (IPC).

The International Patent Classification (IPC) is configured from a higher level patent classification, and from patent classifications of plural hierarchical layers of lower level patent classification of hierarchical layers below the higher level patent classification, and is configured with respective classification layers of class C0, subclass C1, main-group C2, subgroup C3, and the like, in sequence from high level hierarchical layer toward low level hierarchical layer. Note that in cases in which definitions of contracting states of the IPC have defined classifications finer than subgroups, then these classifications may also be employed. Moreover, hierarchical layer numerical values after “/” in the IPC subgroups may be used for detailed division and selection.

Patent publications are employed in the present specification to mean registration publications and laid-open publications. Moreover, patent publications are employed in the present specification with a meaning that includes not only publications issued in Japan, but also publications issued in other states.

Any type of patent publication from out of “registration publication”, “laid-open publication”, or “both registration publication and laid-open publication” may be selected by a selection operation on the publication type selection field 51C.

Any length of issue period of patent publications from out of “past one year”, “past plural years (for example 3 years)”, “particular year (for example year 2021)”, or “plural particular years (for example from year 2018 to year 2021”) may be selected by a selection operation on the issue period selection field 51D.

Any issuing state of patent publications from out of “Japan (JP)”, “United States of America (US)”, “Europe (EP)”, “China (CN)”, “All states”, or the like may be selected by a selection operation on the issuing state selection field 51E.

For example, the company COM1 may be selected by a selection operation on the company selection field 51A. The business activity “All business activities” may be selected by a selection operation on the business activity acquisition instruction field 51B. “Laid-open publications” may be selected by a selection operation on the publication type selection field 51C. The issue period for patent publications of “past one year” may be selected by a selection operation on the issue period selection field 51D. The patent publications issuing state “United States of America (US)” may be selected by a selection operation on the issuing state selection field 51E.

The selected company “COM1” becomes the applicant, and laid-open patent publications issued in the past one year in the “United States of America (US)” that are appended with higher level patent classification “subclass C1” corresponding to the selected business activity “All business activities” are acquired from the database 71 of the server 70 according to these selection operations.

The screen of the display device 67 of the terminal 60 then transition to an acquisition screen 52 illustrated in FIG. 7B. The acquisition screen 52 is configured as an interface screen including the functions of the acquisition section 110.

An acquisition publication display field 52A is provided on the acquisition screen 52.

The acquisition publication display field 52A is displayed with a list of laid-open patent publications G (in the past one year for United States of America (US)) having the selected company “COM1” as the applicant and appended with higher level patent classification “subclass C1” corresponding to the selected business activity “All business activities”.

The display content of the acquisition publication display field 52A includes information of a total number na of patent publications, type (laid-open) G1, patent numbers (application laid-open numbers) G2, appended classification names SP of a lower level patent classification “subgroup C3”, a total item number Na3 of the appended lower level patent classification “subgroup C3”, and appended genera N of the lower level patent classification “subgroup C3” (S11).

### Count Processing S12 by Count Section 120

The count section 120 counts the appended genera N of the lower level patent classification appended to the patent publications acquired by the acquisition section 110. The appended genera N of the lower level patent classification appended to the patent publications acquired by the acquisition section 110 is preferably counted after removing duplicates (S12).

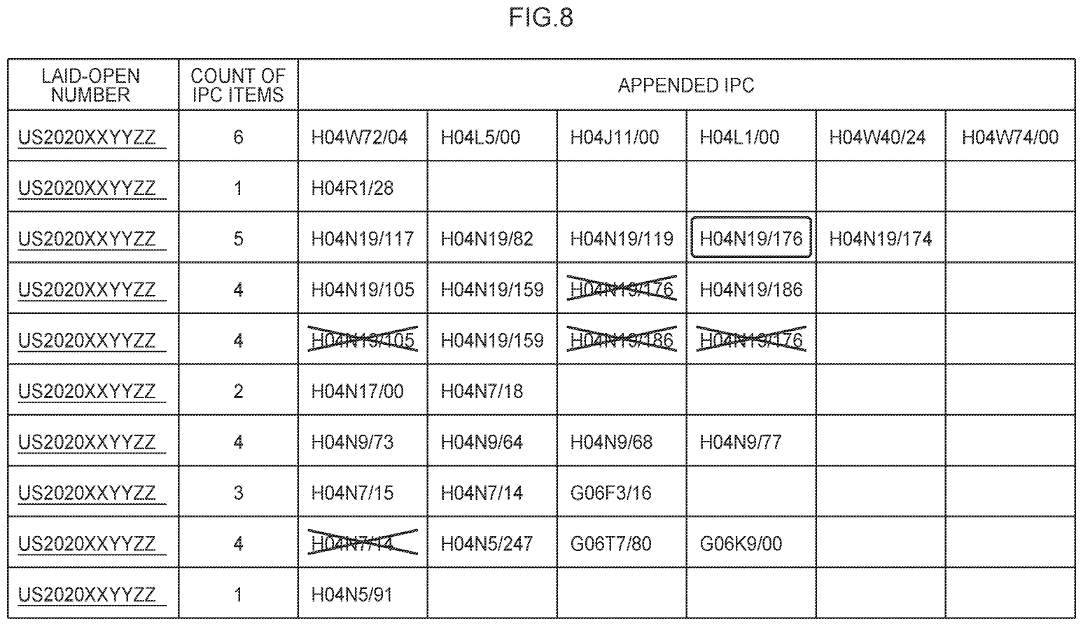

FIG. 8 is a diagram to explain the appended genera N and illustrates content corresponding to the acquisition publication display field 52A illustrated in FIG. 7B.

As illustrated in FIG. 8, the number of items of the lower level patent classification “subgroup C3” resulting from removing the number of duplicates indicated by “×” in FIG. 8 from the total item number C4 (for example 8554 items) of the lower level patent classification “subgroup C3” is counted as the appended genera N of the lower level patent classification “subgroup C3” (for example 2877 items). Note that the appended genera N may be corrected by a correction coefficient according to a size of the patent publications total number na (for example 2170 documents), or according to a difference or ratio to a number of patent documents already contained in a subclass overall, or according to a ratio of an average document number contained respectively in a subgroup and in a main-group (S12).

### Estimation Processing S13 by Estimation Section 130

The estimation section 130 uses a correlation LN of the appended genera N of the lower level patent classification “subgroup C3” as counted by the count section 120 correlated with a business activity size S of the company COM estimation-subject and/or a size S of estimation-subject business activity, to estimate the business activity size S of the company COM estimation-subject and/or the size S of estimation-subject business activity (S13).

The business activity size S corresponds to a company capability Sa, business activity revenue Sb, and/or a business activity budget allocation Sc.

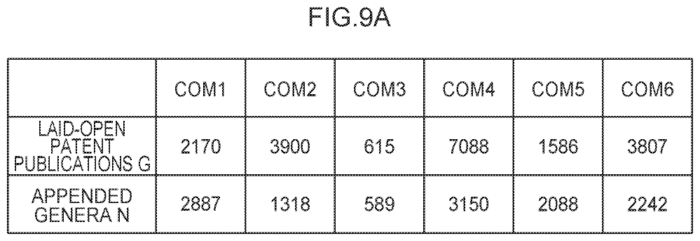

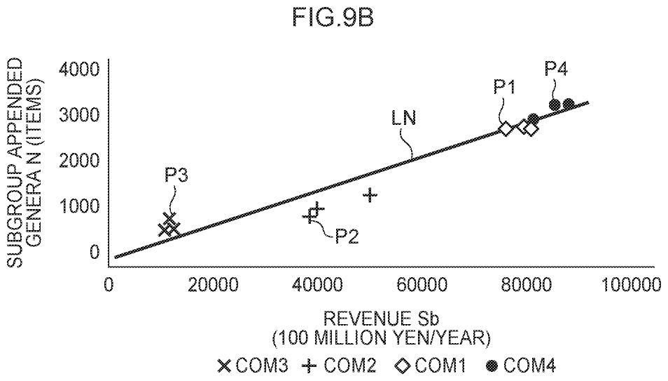

FIG. 9A illustrates an example of appended genera N (items) of a lower level patent classification “subgroup C3” appended to laid-open patent publication G (US, year 2020) that have been appended with a higher level patent classification “subclass C1” corresponding to “all business activities”, with the appended genera N (items) associated with each company COM1, COM2, COM3, COM4, COM5, COM6. Note that a similar trend to that of FIG. 9A is illustrated in other years.

FIG. 9B illustrates an example of a correlation LN pre-stored in the database 71 of the server 70. The correlation LN is illustrated for all business activity revenue Sb per year (in 100 million yen/year) of companies COM on the horizontal axis correlated with the appended genera N (items) of the lower level patent classification “subgroup C3” on the vertical axis. The appended genera N (items) of the lower level patent classification “subgroup C3” for each company COM1, COM2, COM3, COM4 illustrated in FIG. 9A is illustrated by P1, P2, P3, P4 in FIG. 9B plotted according to all business activity revenue Sb for each company COM1, COM2, COM3, COM4. The correlation LN is acquired by finding a regression line for plots P1, P2, P3, P4.

This means that, by using the correlation LN stored in the database 71 of the server 70, the all business activity revenue Sb (100 million yen/year) corresponding to the appended genera N (items) can be estimated when given the appended genera N (items) of the lower level patent classification “subgroup C3” appended to the patent publications of company COM1. The estimated result is displayed on an estimation screen of the display device 67 of the user-side terminal 60 in text format, graph format, or the like (S13).

The target for estimation can be freely determined. The revenue Sb of a particular business activity (for example semiconductor devices: subclass H01L) for a particular company (for example COM1) may be estimated. The revenue Sb (market size) of a particular business activity (for example semiconductor devices: subclass H01L) may also be estimated for all companies.

Data indicating a relationship between appended genera N (items) and revenue Sb of the lower level patent classification “subgroup C3” is stored in the database 71 of the server 70 in a data table format.

Although an example is given in which the “subgroup C3” is determined as the lower level patent classification, so as to estimate the business activity size S using appended genera N (items) thereof, the business activity size S may be estimated using the appended genera N (items) of the main-group C2. Similarly, the business activity size S may be estimated using the appended genera N (items) of the subclass C1. Similarly, the business activity size S may be estimated using the appended genera N (items) of the class C0.

Explanation follows regarding each Example.

### First Example

The relative size of the appended genera N (items) of the lower level patent classification may be displayed.

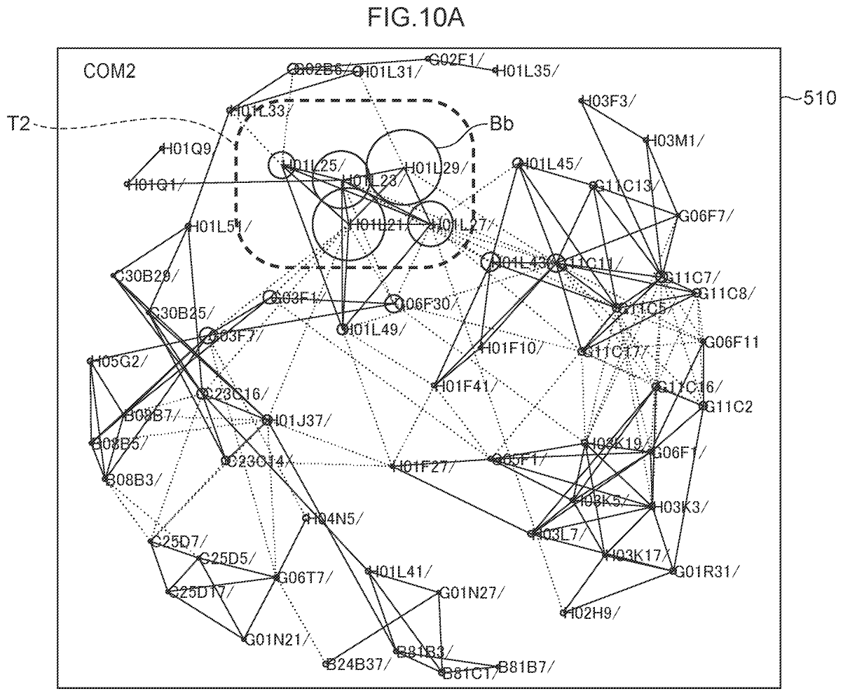

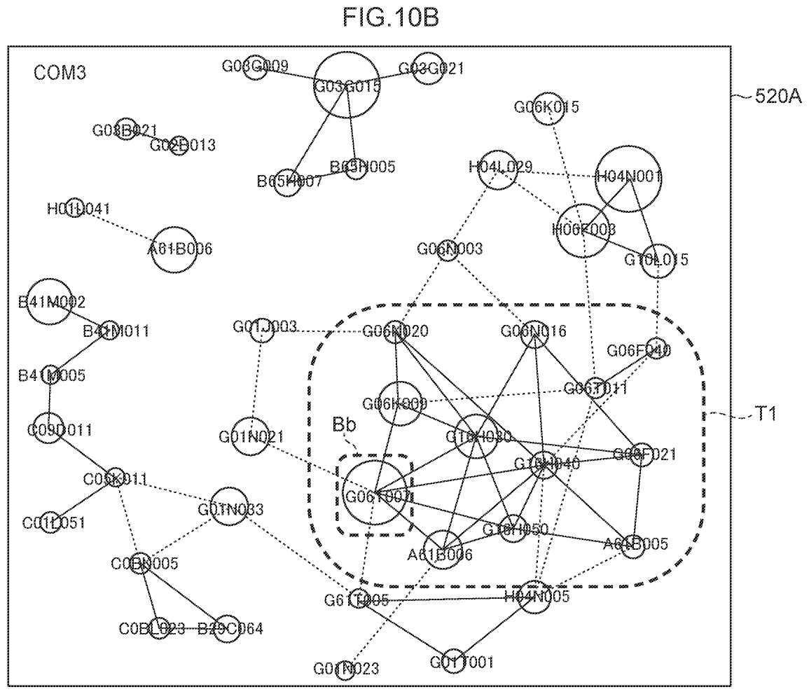

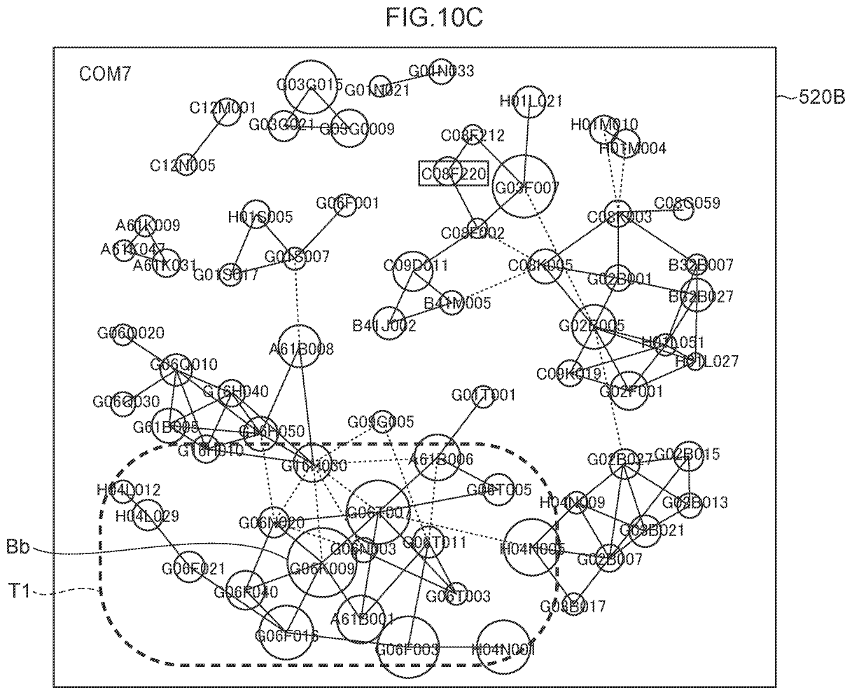

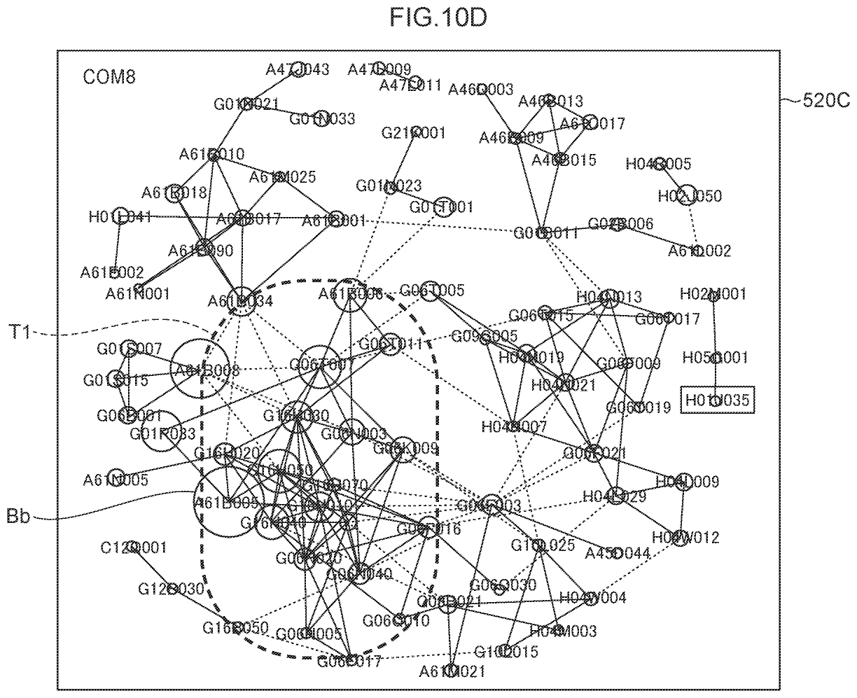

FIG. 10A illustrates an example of an estimation screen 510 of the display device 67 of the user-side terminal 60.

The estimation screen 510 illustrates an example in which the appended genera N (items) of the subgroup C3, the lower level patent classification, have been counted for each category of the higher level patent classification (main-group C2) for the particular company COM2 and are displayed by relative sized bubbles Bb. Note that this relationship diagram is a co-occurrence map created from a collection of patents of the company COM2 based on the plural IPC main-groups appended to each patent. It is apparent from the estimation screen 510 illustrated in FIG. 10A that the particular company COM2 has relatively large sized bubbles Bb corresponding to the business activity of semiconductor fabrication (H01 21/, H01 23/, H01 25/, H01 27/, H01 29/ of main-group C2) as indicated encircled by the broken line T2, and it can be estimated therefrom that revenue Sb of the business activity of semiconductor fabrication make up a relatively large proportion from out of all business activities.

FIG. 10B, FIG. 10C, and FIG. 10D respectively illustrate examples of estimation screens 520A, 520B, 520C of the display device 67 of the user-side terminal 60. Note that the estimation screens 520A, 520B, 520C may be displayed on the same screen of the display device 67.

The estimation screens 520A, 520B, 520C respectively illustrate examples in which the appended genera N (items) of the subgroup C3, the lower level patent classification, have been counted for each category of the hierarchal level patent classification (main-group C2) for the particular companies COM3, COM7, COM8 and are displayed by relative sized bubbles Bb. The capability Sa of each of the competing companies COM3, COM7, COM8 can be quantitatively estimated by comparing the estimation screens 520A, 520B, 520C. For example, the respective capabilities Sa of the competing companies COM3, COM7, COM8 can be compared in the business activity of examination/diagnostics (X-ray diagnostic devices) as indicated encircled by the broken line T1.

### Second Example

A timewise change rate of the appended genera N of the lower level patent classification may be computed, and a change in business activity size of the estimation-subject company and/or a change in size of the estimation-subject business activity may be estimated according to the timewise change rate of the computed appended genera N of the lower level patent classification.

The change in the business activity size S corresponds to a change in capability Sa, a change in revenue Sb of the business activity, a change in business activity budget allocation Sc, and/or a business activity trend Sd.

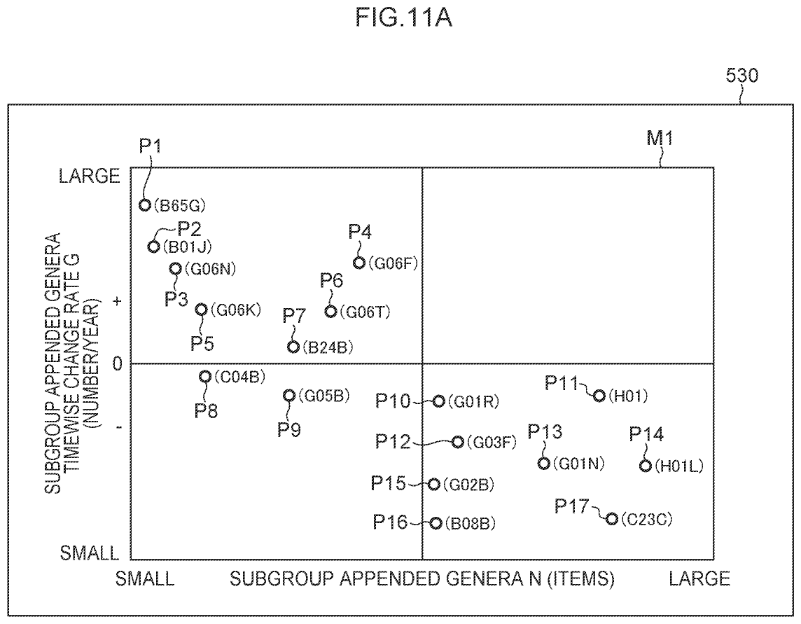

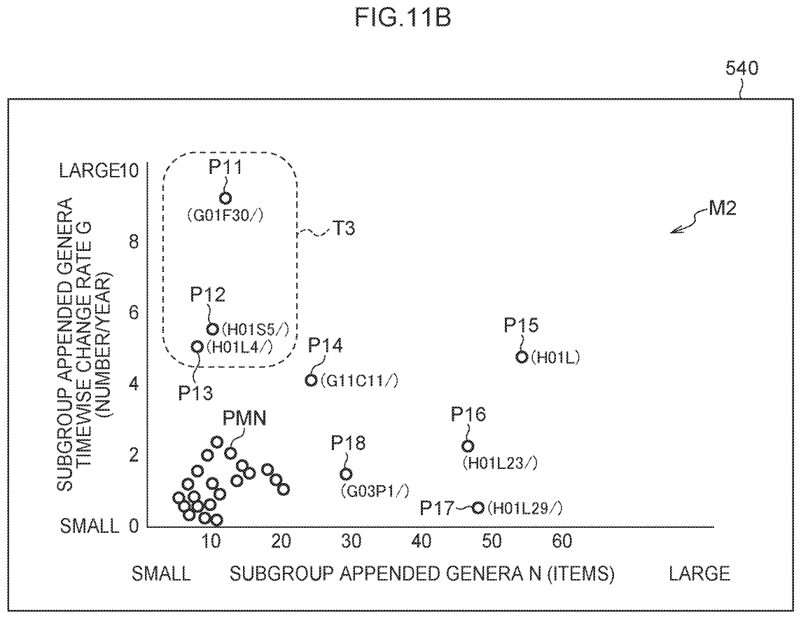

FIG. 11A illustrates an example of an estimation screen 530 of the display device 67 of the user-side terminal 60.

The appended genera N (items) of the subgroup C3, the lower level patent classification, are similarly counted for each category of the higher level patent classification (main-group C2), and the timewise change rate G (growth number/year) of the appended genera N of the subgroup C3 is also computed for plural (for example 15) companies COM11 to 25 engaged in business activities related to semiconductor fabrication devices. The timewise change rate G (growth number/year) of the appended genera N of the subgroup C3 is computed for units of one year, with an increases (growth) direction denoted by + and a decrease direction denoted by −.

A map M1 is displayed on the estimation screen 530 illustrated in FIG. 11A, with the appended genera N (items) of the subgroup C3 counted for each category of the main-group C2 plotted on the horizontal axis and the timewise change rate G (number/year) of the appended genera N of the subgroup C3 counted in the main-group C2 plotted on the vertical axis. The appended genera N (items) of the subgroup C3 on the horizontal axis of the map M1 are average values for each year of the appended genera N of the subgroup C3 for each of the companies COM11 to 25. Similarly, the timewise change rate G (number/year) of the appended genera N of the subgroup C3 on the vertical axis of the map M1 are also average values for each year. The horizontal axis of the map M1 indicates the importance of technology, and the vertical axis of the map M1 indicates the growth/activity level of the technology.

Coordinate points P1 to P17 are plotted on the map M1 for each main-group C2 classification name. This accordingly enables the business activity trend Sd related to semiconductor fabrication devices to be predicted from the position of each of the plot points P1 to P17 on the map M1.

FIG. 11B illustrates an example of an estimation screen 540 of the display device 67 of the user-side terminal 60.

The appended genera N (items) of the subgroup C3, the lower level patent classification, are similarly counted for each category of the higher level patent classification (main-group C2) for the particular company COM2 engaged in business activities related to semiconductor fabrication devices, and the timewise change rate G (growth number/year) of the appended genera N of the subgroup C3 is also computed therefor.

A map M2 similar to that illustrated in FIG. 11A is displayed on the estimation screen 540 illustrated in FIG. 11B. The appended genera N (items) of the subgroup C3 on the horizontal axis of the map M2 are average values over plural years (for example 4 year periods). Similarly, the timewise change rate G (growth number/year) of the appended genera N of the subgroup C3 on the vertical axis of the map M2 are also average values over plural years (for example 4 year periods).

A business activity trend Sd of the particular company COM2 can be predicted from the position of each of the plot points P11, P12, P13, . . . PMN on the map M2. For example, it is apparent that the growth/activity level is high for the technology of particular IPC business activities (G06F 30/, H01S 5/, H01L 41/ of main-group C2) inside the broken line T3.

### Third Example

The granularity of the appended genera N of the subclass C1 can be freely set.

For example, as illustrated in the First Example and the Second Example, the appended genera N may be counted for each category of the main-group C2, which is the higher level patent classification of the hierarchical layer one hierarchical layer above the subgroup C3, which is the lower level patent classification.

Moreover, the appended genera N may be counted for each category of the subclass C1, which is the higher level patent classification of the hierarchical layer two hierarchical layers above the subgroup C3, which is the lower level patent classification.

Moreover, the appended genera N may be counted for each category of the class C0, which is the higher level patent classification of the hierarchical layer three hierarchical layers above the subgroup C3, which is the lower level patent classification.

The count values of the appended genera N of the subgroup C3, which is the lower level patent classification, increase as the hierarchical layer of the higher level patent classification progresses through being the higher hierarchal layer of the main-group C2, the subclass C1, and the class C0. For example, the appended genera N (items) of the subgroup C3 counted for each category of the subclass C1, and the timewise change rate G (number/year) of the appended genera N of the subgroup C3 counted for each category of the subclass C1, may be respectively plotted on the horizontal axis and the vertical axis of the maps M1, M2 illustrated in FIG. 11A and FIG. 11B. Moreover, the appended genera N (items) of the subgroup C3 counted for each category of the class C0, and the timewise change rate G (number/year) of the appended genera N of the subgroup C3 counted for each category of the class C0, may be respectively plotted on the horizontal axis and the vertical axis of the maps M1, M2 illustrated in FIG. 11A and FIG. 11B.

### Fourth Example

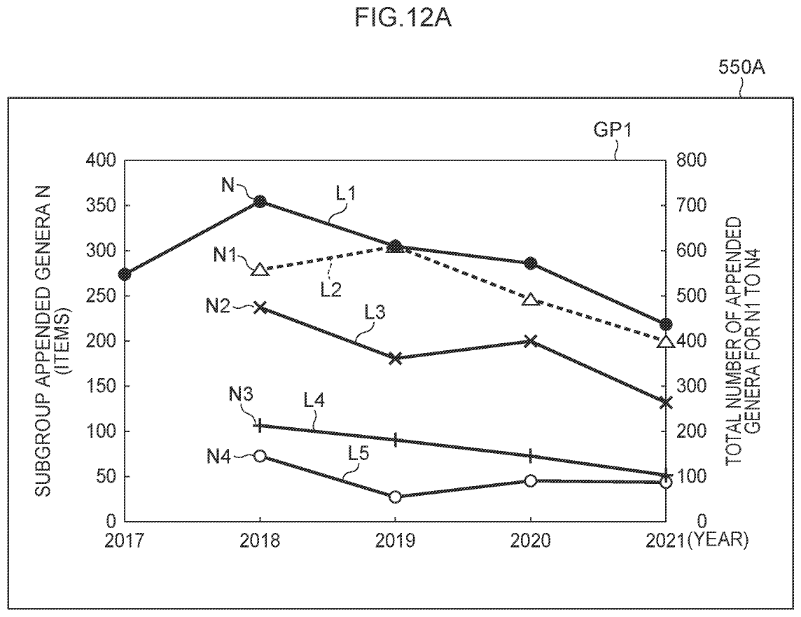

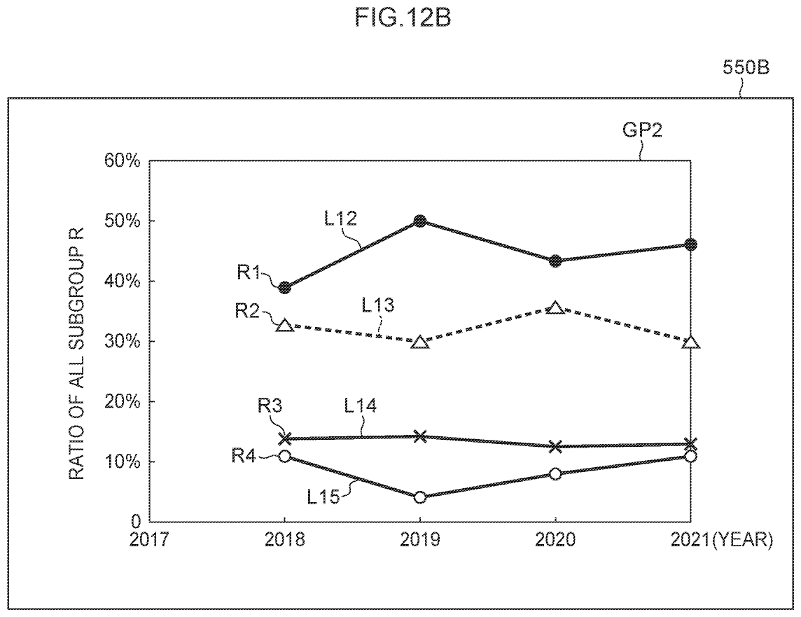

Examples of estimation screens 550A, 550B of the display device 67 of the user-side terminal 60 are respectively illustrated in FIG. 12A and FIG. 12B. Note that the estimation screens 550A, 550B may be displayed on the same screen of the display device 67.

The appended genera N (items) of the subgroup C3, the lower level patent classification, are counted for all business activities of the particular company COM3 for each year and for each higher level patent classification of each of the higher hierarchal layers.

Each year (2017, 2018, 2019, 2020, 2021) is indicated on the horizontal axis of graph GP1 illustrated in FIG. 12A, and the appended genera N (N, N1, N2, N3, N4) (items) of the subgroup C3 are indicated on the vertical axis thereof.

The bent line L1 illustrates the appended genera N of the subgroup C3 (called the all appended genera N).

The bent line L2 indicates the appended genera N1 of the subgroup C3 for the same category in the current year to in the previous year (called existing appended genera N1).

The bent line L3 indicates the appended genera N2 of the subgroup C3 not present in the previous year and new in the current year appended as belonging to the main-group C2 of the same category (called first emerging appended genera N2).

The bent line L4 indicates the appended genera N3 of the subgroup C3 not present in the previous year and new in the current year appended as belonging to the subclass C1 of the same category but belonging to a main-group C2 of a different category to the previous year (called second emerging appended genera N3).

The bent line L5 indicates an appended genera N4 of the subgroup C3 not present in the previous year and new in the current year appended as belonging to the class C0 of the same category but belong to a subclass C1 of a different category to in the previous year (called novel appended genera N4).

Each year (2017, 2018, 2019, 2020, 2021) is indicated on the horizontal axis of graph GP2 illustrated in FIG. 12B, and a ratio R (R1, R2, R3, R4) of the respective appended genera N1, N2, N3, N4 (items) of the subgroup C3 illustrated in FIG. 12B with respect to the all appended genera N is indicated on the vertical axis in FIG. 12A.

The bent line L12 is a bent line corresponding to the bent line L2, and indicates the ratio R1 of the existing appended genera N1 with respect to the all appended genera N.

The bent line L13 is a bent line corresponding to the bent line L13, and indicates the ratio R2 of the first emerging appended genera N2 with respect to the all appended genera N.

The bent line L14 is a bent line corresponding to the bent line L14, and indicates the ratio R3 of the second emerging appended genera N3 with respect to the all appended genera N.

The bent line L15 is a bent line corresponding to the bent line L15, and indicates the ratio R4 of the novel appended genera N4 with respect to the all appended genera N.

The existing appended genera N1 and the ratio R1 of the existing appended genera N1 correspond to the budget allocation Sc of existing business activities. This means that the budget allocation Sc of existing business activities of the particular company COM3 can be estimated using the existing appended genera N1 and the ratio R1 of the existing appended genera N1.

The first emerging appended genera N2 and the ratio R2 of the first emerging appended genera N2 correspond to the budget allocation Sc of areas of emerging novel business activities. This means that the budget allocation Sc of the areas of emerging novel business activities of the particular company COM3 can be estimated using the first emerging appended genera N2 and the ratio R2 of the first emerging appended genera N2.

The second emerging appended genera N3 and the ratio R3 of the second emerging appended genera N3 correspond to the budget allocation Sc of areas of emerging novel business activities. This means that the budget allocation Sc of the areas of emerging novel business activities of the particular company COM3 can be estimated using the second emerging appended genera N3 and the ratio R3 of the second emerging appended genera N3.

The novel appended genera N4 and the ratio R4 of the novel appended genera N4 correspond to the budget allocation Sc of areas of emerging novel business activities. This means that the budget allocation Sc of novel business activities of the particular company COM3 can be estimated using the novel appended genera N4 and the ratio R4 of the novel appended genera N4.

### Second Exemplary Embodiment

Description follows regarding a second exemplary embodiment. Description will be omitted as appropriate for configuration and processing duplicating that of the first exemplary embodiment.

The business activity size estimation device 200 of the second exemplary embodiment includes a first acquisition section 210, a second acquisition section 220, a first count section 230, a second count section 240, a computation section 250, and an estimation section 260, for executing a program PB1B of the processing sequence illustrated in FIG. 6B.

First Acquisition Processing S21 by First Acquisition Section 210 and Second Acquisition Processing S22 by Second Acquisition Section 220

The first acquisition section 210 acquires patent publications appended with a higher level patent classification “main-group C2” corresponding to an estimation-subject business activity (S21). The second acquisition section 220 acquires patent publications having the estimation-subject company as the applicant from out of the patent publications acquired by the first acquisition section 210 (S22).

The acquisition processing may be performed in a similar manner to in FIG. 7A and FIG. 7B.

A user is able to perform an operation on a selection screen 51 to select the estimation-subject company and the estimation-subject business activity.

For example, the company “COM2” may be selected by a selection operation on a company selection field 51A. The business activity of “semiconductor fabrication” may be selected by a selection operation on a business activity acquisition instruction field 51B. “Laid-open publications” may be selected by a selection operation on a publication type selection field 51C. The patent publication issue period of “year 2021” may be selected by a selection operation on an issue period selection field 51D. The patent publications issuing state “United States of America (US)” may be selected by a selection operation on an issuing state selection field 51E.

According to these selection operations, laid-open patent publications Ga issued in “year 2021” in the “United States of America (US)” that are appended with higher level patent classification “main-group C2” (H01L 021/, H01L 023/) corresponding to the selected business activity “semiconductor fabrication” are acquired from the database 71 of the server 70 (S21).

Laid-open patent publications Gc2 for which the selected company “COM2” is the application are selected from out of these laid-open patent publications Ga, namely laid-open patent publications Gc2 issued in “year 2021” for “United States of America (US)” that are appended with the higher level patent classification “main-group C2” (H01L 021/, H01L 023/) corresponding to the selected business activity “semiconductor fabrication” and that have the selected company “COM2” as the applicant are acquired from the database 71 of the server 70 (S21).

### Count Processing S23 by First Count Section 230 and Count Processing S24 by Second Count Section 240

The first count section 230 counts first appended genera N with the lower level patent classification “subgroup C3” appended to the patent publications Ga acquired by the first acquisition section 210 (S23). The second count section 240 counts second appended genera NC2 with the lower level patent classification “subgroup C3” appended to the patent publications Gc2 acquired by the second acquisition section 220 (S24). Note that the first appended genera N and the second appended genera NC2 are both preferably counted while removing duplicates during counting.

### Computation Processing S25 by Computation Section 250

The computation section 250 computes an appended genera share NC2/N by dividing the second appended genera NC2 of the lower level patent classification “subgroup C3” by the first appended genera N of the lower level patent classification “subgroup C3”. The appended genera share NC2/N corresponds to a business activity size share of the selected estimation-subject company “COM2” (S25).

### Estimation Processing S26 by Estimation Section 260

The estimation section 260 uses the appended genera share NC2/N computed by the computation section 250 to estimate a business activity size share Sr made up by a business activity size Sc2 of the estimation-subject company “COM2” in the size S of the estimation-subject business activity “semiconductor fabrication”. The estimation result is displayed on an estimation screen of the display device 67 of the user-side terminal 60 in a text format, graph format, or the like (S26).

### Fifth Example

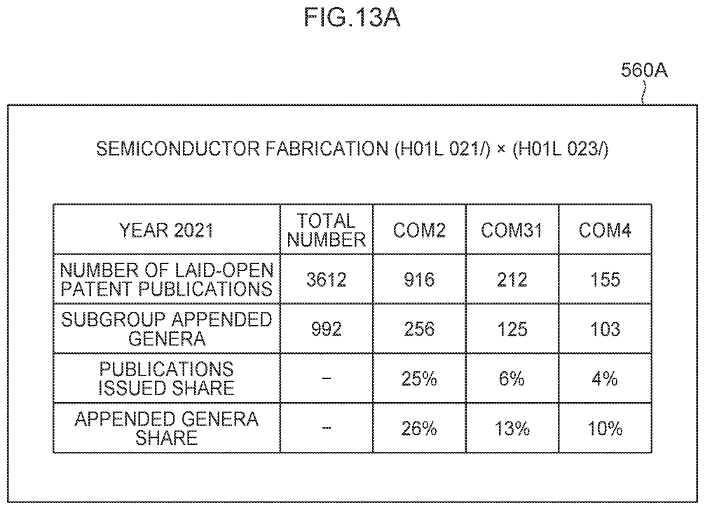

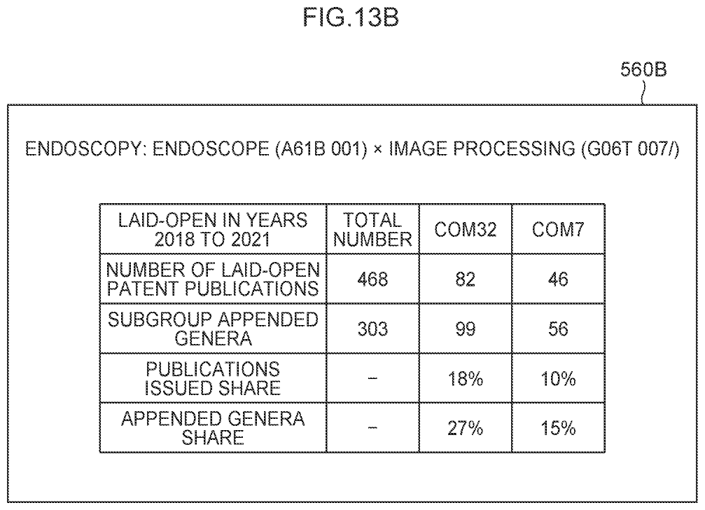

FIG. 13A illustrates an example of an estimation screen 560A of the display device 67 of the user-side terminal 60.

A total issue number na (for example 3612 documents) is displayed on the estimation screen 560A indicating the laid-open patent publications Ga issued in “year 2021” in “United States of America (US)” that are appended with the higher level patent classification “main-group C2” (H01L 021/, H01L 023/) corresponding to the business activity “semiconductor fabrication”.

The first appended genera N (for example, 992 items) of the lower level patent classification “subgroup C3” appended to the laid-open patent publications Ga are displayed on the estimation screen 560A.

An issue number nc2 (for example 916 documents) is displayed on the estimation screen 560A indicating the laid-open patent publications Gc2 issued in “year 2021” in “United States of America (US)” that are appended with the higher level patent classification “main-group C2” (H01L 021/, H01L 023/) corresponding to the business activity of “semiconductor fabrication” and having the selected company “COM2” as the applicant.

A second appended genera NC2 (for example 256 items) indicating the lower level patent classification “subgroup C3” appended to the laid-open patent publications Gc2 is also displayed on the estimation screen 560A.

An appended genera share NC2/N (0.26=26%) of the selected company “COM2” is also displayed on the estimation screen 560A.

A number of publications issued share nc2/na (0.25=25%) of the selected company “COM2” is also displayed on the estimation screen 560A.

For comparison, the estimation screen 560A is also displayed with an issue number nc31 (for example 212 documents), a second appended genera NC31 (for example 125 items), an appended genera share NC31/H (0.13=13%), and a number of publications issued share nc31/na (0.06=6%) for the laid-open patent publications Gc31 of another company

“COM31”, and is also displayed with an issue number nc4 (for example 155 documents), a second appended genera NC4 (for example 103 items), an appended genera share NC4/H (0.10=10%), and a number of publication issued share nc4/na (0.04=4%) for the laid-open patent publications Gc4 of another different company “COM4”.

It is apparent from the estimation screen 560A that the company “COM2” has an appended genera share NC2/N (0.26=26%) that is larger that of the other companies, and a high business activity size share Sr related to the business activity of “semiconductor fabrication” may be estimated therefrom.

FIG. 13B illustrates an example of another estimation screen 560B of the display device 67 of the user-side terminal 60.

The estimation screen 560B is displayed with a total issue number na (for example 468 documents) of the laid-open patent publications Ga issued “from year 2018 to year 2021” in the “United States of America (US)” that are appended with higher level patent classification “main-group C2” (A61B 001/ G06T 007/) corresponding to the business activity of “endoscopy”.

The first appended genera N (for example 363 items) of the lower level patent classification “subgroup C3” appended to the laid-open patent publications Ga is also displayed on the estimation screen 560B.

The estimation screen 560B is also displayed with an issue number nc32 (for example 82 documents) of the laid-open patent publications Gc32 issued “from year 2018 to year 2021” in the “United States of America (US)” that are appended with higher level patent classification “main-group C2” (A61B 001/, G06T 007/) corresponding to the intersection of “image processing” related to the business activity “endoscopy” and having selected company “COM32” as the applicant.

The estimation screen 560B is also displayed with second appended genera NC32 (for example 99 items) of the lower level patent classification “subgroup C3” appended to the laid-open patent publications Gc32.

The estimation screen 560B is also displayed with an appended genera share NC32/N (0.27=27%) of the selected company “COM32”.

The estimation screen 560B is also displayed with a number of publications issued share nc32/na (0.18=18%) of the selected company “COM32”.

The estimation screen 560B is also, for comparison, displayed with a number issued nc7 (for example 46 documents) of the laid-open patent publications Gc7, a second appended genera NC7 (for example 56 documents), an appended genera share NC7/N (0.15=15%), and a number of publications issued share nc7/na (0.10=10%) of another company “COM7”.

It is apparent from the estimation screen 560B that the company “COM32” has an appended genera share NC32/N (0.27=27%) larger than other companies, and a high business activity size share Sr related to the business activity of “endoscopy” using “image processing” may be estimated therefrom.

### Third Exemplary Embodiment

Description follows regarding a third exemplary embodiment. Description will be omitted as appropriate for configuration and processing duplicating those of the first exemplary embodiment and the second exemplary embodiment.

The business activity size estimation device 300 of the third exemplary embodiment includes an acquisition section 310, a result value acquisition section 320, a count section 330, and a prediction model generation section 340, for executing a program PB1C of the processing sequence illustrated in FIG. 6C.

Acquisition Processing S31 by Acquisition Section 310

The acquisition section 310 respectively acquires patent publications Gc32, Gc33, Gc34, . . . , Gc47 having the plural (for example 16) companies COM32, COM33, COM34, . . . COM47 estimation-subject as the applicant S31.

### Result Value Acquisition Processing S32 by Result Value Acquisition Section 320

The result value acquisition section 320 acquires a business activity size result value Sk indicating a result value (for example a result value of revenue Sb of an electric machinery business activity) Sk of a size (for example revenue Sb) of the business activity (“electric machinery business activity”) corresponding to higher level patent classification “subclass C1” (“cx1”, “cx2”, “cx3”, “cx4”, “cx5”, “cx6”) appended to patent publications Gc32, Gc33, Gc34, . . . , Gc47 acquired by the acquisition section 310. The business activity size result value Sk (for example a result value of the electric machinery business activity revenue Sb) is, for example, read and acquired from the database 71 of the server 70. Note that “cx1”, “cx2”, “cx3”, “cx4”, “cx5”, “cx6” respectively indicate classification names of the subclass C1 such as “G03G” or the like. Note that although as an example here 6 categories of subclass are taken as variables, obviously a method may be utilized that increases or decreases the number of categories according to information of multi-variant analysis (S32). Count Processing S33 by Count Section 330

The count section 330 counts appended genera Nk1, Nk2, Nk3, Nk4, Nk5, Nk6 of the lower level patent classification “subgroup C3” for each of the categories “cx1”, “cx2”, “cx3”, “cx4”, “cx5”, “cx6” of the higher level patent classification (subclass C1) appended to the patent publications Gc32, Gc33, Gc34, . . . , Gc47 acquired by the acquisition section 310 (S33).

### Prediction Model Generation Processing S34 by Prediction Model Generation Section 340

Based on the appended genera count values Nk1, Nk2, Nk3, Nk4, Nk5, Nk6 of the lower level patent classification “subgroup C3” counted for each of the categories “cx1”, “cx2”, “cx3”, “cx4”, “cx5”, “cx6” of the higher level patent classification (subclass C1) counted by the count section 330, and based on the business activity size result value Sk acquired by the result value acquisition section 320, the prediction model generation section 340 generates a business activity size prediction model M for predicting appended genera Nx1, Nx2, Nx3, Nx4, Nx5, Nx6 of the lower level patent classification and/or predicting a size Sy of a business activity. The business activity size prediction model M is a model in which the appended genera Nx1, Nx2, Nx3, Nx4, Nx5, Nx6 of the lower level patent classification “subgroup C3” counted for each of the categories “cx1”, “cx2”, “cx3”, “cx4”, “cx5”, “cx6” of the higher level patent classification (subclass C1) are explanatory variables, and the business activity size (for example the revenue Sb of a business activity) Sy is the objective variable (S34).

### Sixth Example

An analytical approach such as linear regression analysis, including simple regression analysis and multiple regression analysis, may be applied in the business activity size prediction model M. Other than linear regression, a method such as regression by main component analysis, LASSO regression, RIDGE regression, or the like may also be applied in the business activity size prediction model M. For example, a non-linear regression analysis analytical approach may be applied, such as logistic regression analysis, polynomial regression analysis, or the like.

A business activity size prediction model M applying multiple regression analysis may be represented by the following Equation (1).

$$Sy = β0 + β1 \cdot Nx 1 + β2 \cdot Nx 2 + β3 \cdot Nx 3 + β4 \cdot Nx 4 + β5 \cdot Nx 5 + β6 \cdot Nx 6 \qquad ( 1 )$$

Regression coefficients β0, β1, β2, β3, β4, β5, β6 are found so as to minimize a sum of the squares of differences between the respective appended genera count values Nk1, Nk2, Nk3, Nk4, Nk5, Nk6 of the “subgroup C3” acquired for each company COM32, COM33, COM34, . . . , COM47, and the data of the business activity size result value (for example electric machinery business activity revenue Sb) Sk acquired for each company COM32, COM33, COM34, . . . , COM47.

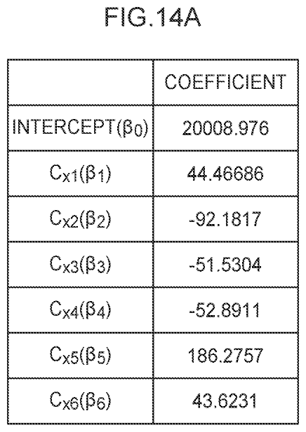

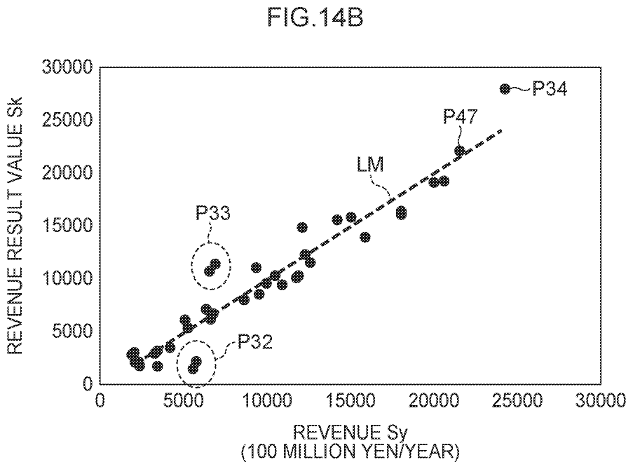

An example of values calculated for the regression coefficients β0, β1, β2, β3, β4, β5, β6 is illustrated in FIG. 14A.

FIG. 14B illustrates a regression curve LM corresponding to the business activity size prediction model M. Business activity revenue Sy computed from the business activity size prediction model M are illustrated on the horizontal axis of FIG. 14B. Revenue result values Sk are indicated on the vertical axis of FIG. 14B.

The respective plot points P32, P33, P34, . . . P47 are plots of the business activity revenue (Sy, Sk) for each company COM32, COM33, COM34, . . . , COM47. Note that cases in which the year is different for the same company are included.

Note that although in the above example of Equation (1), plural (6 items) of the appended genera Nx1, Nx2, Nx3, Nx4, Nx5, Nx6 of the subgroup C3 counted respectively for the categories “cx1”, “cx2”, “cx3”, “cx4”, “cx5”, “cx6” of the higher level patent classification (subclass C1) are all acquired as explanatory variables of the business activity size prediction model M, a single, or a combination of two or more, item from out of the respective appended genera Nx1, Nx2, Nx3, Nx4, Nx5, Nx6 of the subgroup C3 may be acquired as explanatory variables of the business activity size prediction model M. For example, a round-robin approach may be employed, and the combination of appended genera that gives the least difference of squares may be employed as the explanatory variables of the business activity size prediction model M.

### Seventh Example

The business activity size prediction model M is employed to perform an operation in which one or plural numerical values of the appended genera Nx1, Nx2, Nx3, Nx4, Nx5, Nx6 of the subgroup C3 are changed, eliminated, or the like so as to enable a change in the business activity revenue Sy to be predicted. Moreover, the business activity size prediction model M may be employed to perform an operation to set a target value of the business activity revenue Sy so as to enable an optimum appended genera to be predicted in which the respective appended genera Nx1, Nx2, Nx3, Nx4, Nx5, Nx6 of the subgroup C3 are optimally distributed. The business activity size prediction model M is stored in the database 71 of the server 70.

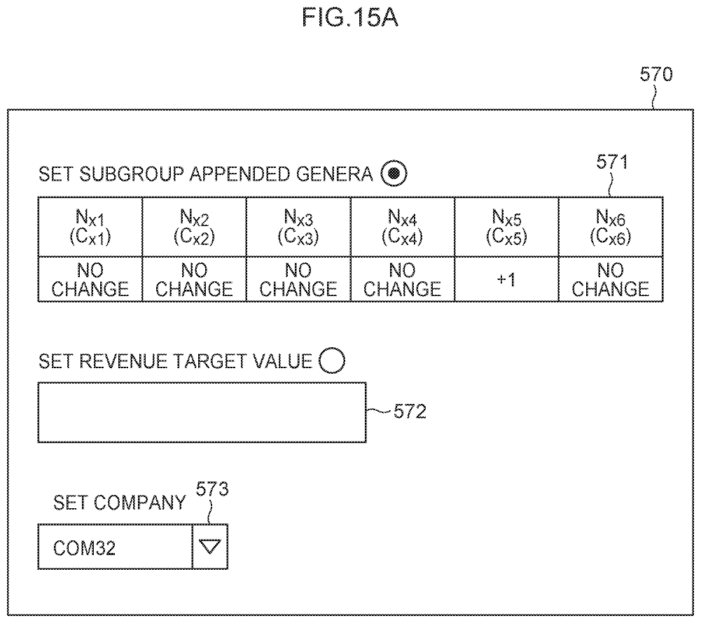

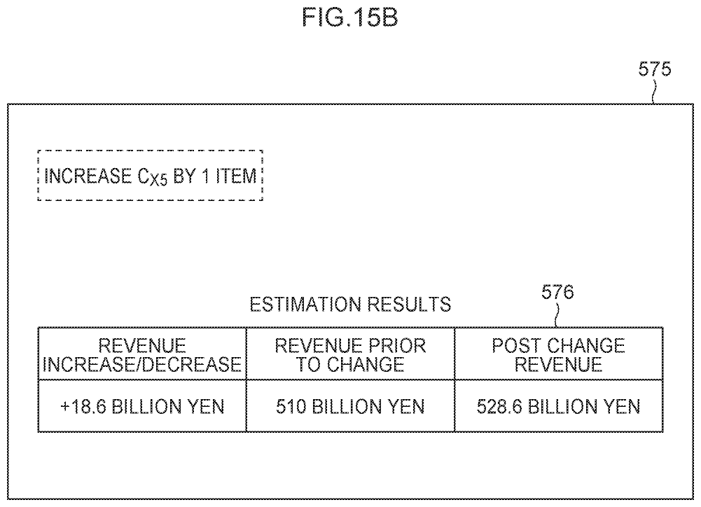

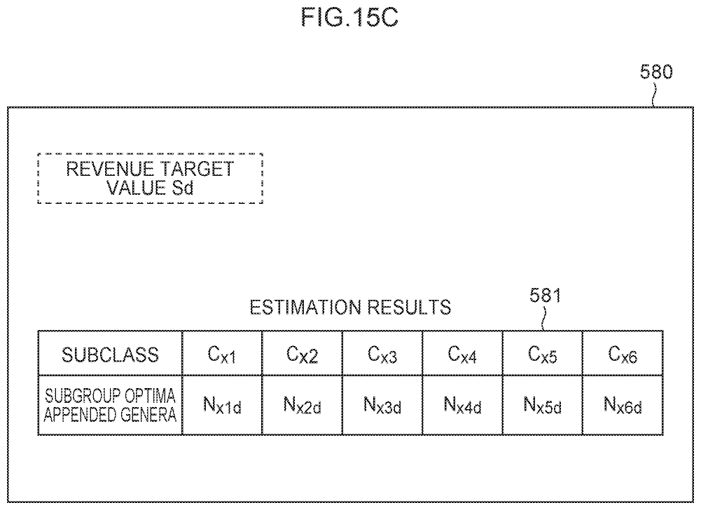

FIG. 15A illustrates an example of an estimation screen 570 of the display device 67 of the user-side terminal 60.

The setting of the estimation condition may be performed on the estimation screen 570.

A user, for example, is able to use a subgroup appended genera setting field 571 of the estimation screen 570 to perform setting to change, eliminate, or the like the appended genera Nx1, Nx2, Nx3, Nx4, Nx5, Nx6 of the subgroup C3.

A user is, for example, able to set a target value Sd of the business activity revenue Sy by using a revenue target value setting field 572 of the estimation screen 570.

A user is able to set the estimation-subject company, for example COM32, by using a company setting field 573 of the estimation screen 570.

For example, consider a case in which a change of “increase by 1 item” is set for the genera of the appended genera Nx5 of the subgroup C3 belonging to the category “cx5” of subclass C1 in a subgroup appended genera setting field 571 of the estimation screen 570, and the estimation-subject company, for example COM32, is set in the company setting field 573. The business activity size prediction model M stored in the database 71 of the server 70 is used and computational processing performed according to this change setting, so as to change the business activity revenue Sy to a case when the genera of the appended genera Nx5 of the subgroup C3 belonging to the category “cx5” of the subclass C1 has been “increased by 1 item” for the set company COM32.

The display screen of the display device 67 of the user-side terminal 60 transitions to an estimation result display screen 575 illustrated in FIG. 15B.

A revenue increase (18.6 billion yen), from business activity revenue Sk of the company COM32 prior to change (for example 510 billion yen) to business activity revenue Sy when the genera of the appended genera Nx5 of the subgroup C3 belonging to the category “cx5” of subclass C1 has been “increased by 1 item” (528.6 billion yen), is displayed in an estimation result display field 576 of the estimation result display screen 575.

Moreover, consider a case in which the target value Sd of the business activity revenue Sy is set in the revenue target value setting field 572 of the estimation screen 570, and the estimation-subject company, for example COM32, is set in the company setting field 573. The business activity size prediction model M stored in the database 71 of the server 70 is used and computational processing is performed according to this target value setting so as to compute each of the optimal appended genera Nx1d, Nx2d, Nx3d, Nx4d, Nx5d, Nx6d of the subgroup C3 according to the target value Sd of the business activity revenue Sy for the set company COM32. For example, the target value Sd of the set business activity revenue Sy is obtained, and the business activity size prediction model M is used to compute the optimal appended genera Nx1d, Nx2d, Nx3d, Nx4d, Nx5d, Nx6d so as to minimize the total appended genera.

The display screen of the display device 67 of the user-side terminal 60 transitions to an estimation result display screen 580 illustrated in FIG. 15C.

The target value Sd of the business activity revenue Sy of the company COM32 and each of the optimal appended genera Nx1d, Nx2d, Nx3d, Nx4d, Nx5d, Nx6d of the subgroup C3 to obtain the target value Sd of the business activity revenue Sy of the company COM32 are displayed on an estimation result display field 581 of the estimation result display screen 580.

1. A business activity size estimation device comprising:
an acquisition section that acquires one or more of patent publications having an estimation-subject company as applicant or patent publications appended with a higher level patent classification corresponding to an estimation-subject business activity;
a count section that counts appended genera of a lower level patent classification appended to the patent publications acquired by the acquisition section; and
an estimation section that uses a correlation of appended genera of the lower level patent classification, as counted by the count section, correlated with one or more of a business activity size of the estimation-subject company or a size of the estimation-subject business activity, to estimate one or more of the business activity size of the estimation-subject company or the size of the estimation-subject business activity.

2. The business activity size estimation device of claim 1, wherein the count section removes duplication from, and counts the appended genera of, the lower level patent classification appended to the patent publications acquired by the acquisition section.

3. The business activity size estimation device of claim 1, wherein the lower level patent classification is an International Patent Classification subgroup, or main-group, or subclass.

4. The business activity size estimation device of claim 1, wherein the estimation section estimates at least one of capability, business activity revenue, or business activity budget allocation.

5. The business activity size estimation device of claim 1, wherein the estimation section estimates at least one of a change in capability, a change in business activity revenue, a change in business activity budget allocation, or a business activity trend, by computing a timewise change rate of appended genera of the lower level patent classification and by estimating one or more of a change of business activity size of the estimation-subject company or a change of size of the estimation-subject business activity, according to the computed timewise change rate of appended genera of the lower level patent classification.

6. The business activity size estimation device of claim 1, wherein the estimation section estimates at least one of a change in capability, a change in business activity revenue, a change in business activity budget allocation, or a business activity trend by computing appended genera of the lower level patent classification for each category of the higher level patent classification and by estimating a change of business activity size for each category of the higher level patent classification according to a timewise change rate of the computed appended genera of the lower level patent classification.

7. The business activity size estimation device of claim 1, wherein the acquisition section includes:
a first acquisition section that acquires patent publications appended with a higher level patent classification corresponding to an estimation-subject business activity;
a second acquisition section that acquires patent publications having an estimation-subject company as applicant from among the patent publications acquired by the first acquisition section;
the count section includes:
a first count section that counts first appended genera of a lower level patent classification appended to the patent publications acquired by the first acquisition section;
a second count section that counts second appended genera of a lower level patent classification appended to the patent publications acquired by the second acquisition section;
the estimation section includes:
a computation section that computes an appended genera share of the second appended genera of the lower level patent classification divided by the first appended genera of the lower level patent classification; and
an estimation section that uses the appended genera share as computed by the computation section to estimate a business activity size share made up by the business activity size of the estimation-subject company in a size of the estimation-subject business activity.

8. The business activity size estimation device of claim 1, wherein the acquisition section includes:
an acquisition section that acquires patent publications having an estimation-subject company as applicant;
a result value acquisition section that acquires a business activity size result value indicating a result value of a size of business activity corresponding to a higher level patent classification appended to the patent publications acquired by the acquisition section;
the count section includes:
a count section that counts appended genera of a lower level patent classification in each category of the higher level patent classification appended to the patent publications acquired by the acquisition section; and
the estimation section includes:
a prediction model generation section that generates a business activity size prediction model that is a prediction model to predict one or more of appended genera of the lower level patent classification or a size of business activity, based on an appended genera count value as counted by the count section for the lower level patent classification in each category of the higher level patent classification and based on the business activity size result value as acquired by the result value acquisition section, and that is a prediction model taking the appended genera of the lower level patent classification as an explanatory variable and the business activity size as an objective variable.

9. The business activity size estimation device of claim 8, wherein the business activity size prediction model is a model taking appended genera of lower level patent classification for each of a plurality of categories of higher level patent classification as a plurality of explanatory variables, and taking a business activity size corresponding to the plurality of categories of the higher level patent classification as the objective variable.

10. A computer-readable storage medium storing a program for causing business activity size estimation to be executed by a computer, the business activity size estimation comprising:acquisition processing to acquire one or more of patent publications having an estimation-subject company as applicant or patent publications appended with a higher level patent classification corresponding to an estimation-subject business activity;
count processing to count appended genera of a lower level patent classification appended to the patent publications acquired by the acquisition processing; and
estimation processing that uses a correlation of the appended genera of the lower level patent classification, as counted by the count processing, correlated with one or more of a business activity size of the estimation-subject company or a size of the estimation-subject business activity to estimate one or more of the business activity size of the estimation-subject company or the size of the estimation-subject business activity.

11. A computer-readable storage medium of claim 10, storing a program for causing business activity size estimation to be executed by a computer wherein the business activity size estimation comprising:
first acquisition processing to acquire patent publications appended with a higher level patent classification corresponding to an estimation-subject business activity;
second acquisition processing to acquire patent publications having an estimation-subject company as applicant from among the patent publications acquired by the first acquisition processing;
first count processing to count first appended genera of a lower level patent classification appended to the patent publications acquired by the first acquisition processing;
second count processing to count second appended genera of a lower level patent classification appended to the patent publications acquired by the second acquisition processing;
computation processing to compute an appended genera share of the second appended genera of the lower level patent classification divided by the first appended genera of the lower level patent classification; and
estimation processing that uses the appended genera share as computed by the computation processing to estimate a business activity size share made up by the business activity size of the estimation-subject company in a size of the estimation-subject business activity.

12. A computer-readable storage medium of claim 10, storing a program for causing business activity size estimation to be executed by a computer, wherein the business activity size estimation comprising:
acquisition processing to acquire patent publications having an estimation-subject company as applicant;
result value acquisition processing to acquire a business activity size result value indicating a result value of a size of business activity corresponding to a higher level patent classification appended to the patent publications acquired by the acquisition processing;
count processing to count appended genera of a lower level patent classification in each category of the higher level patent classification appended to the patent publications acquired by the acquisition processing; and
prediction model generation processing to generate a business activity size prediction model that is a prediction model to predict one or more of appended genera of the lower level patent classification or a size of business activity based on an appended genera count value as counted by the count processing for the lower level patent classification in each category of the higher level patent classification and based on the business activity size result value as acquired by the result value acquisition processing, and that is a prediction model taking the appended genera of the lower level patent classification as an explanatory variable and the business activity size as an objective variable.
